(19) United States
(12) Patent Application Publication
(10) Pub. No.: US 2019/0196873 A1
(43) Pub. Date: Jun. 27, 2019

(54) MANAGEMENT DEVICE AND MANAGEMENT METHOD

(71) Applicant: FUJITSU LIMITED, Kawasaki-shi (JP)

(72) Inventor: Ryosuke Morishita, Kanazawa (JP)

(73) Assignee: FUJITSU LIMITED, Kawasaki-shi (JP)

(21) Appl. No.: 16/220,882

(22) Filed: Dec. 14, 2018

(30) Foreign Application Priority Data
Dec. 27, 2017 (JP) 2017-252623

(51) Int. Cl. G06F 9/50; G06F 9/455

(52) U.S. Cl. CPC G06F 9/505; G06F 2009/45595; G06F 2009/4557; G06F 9/45558

(57) ABSTRACT

A management device includes one or more memories, and one or more processors configured to perform first addition of a second device by first scale-out processing with regard to a first device in accordance with a load of the first device, and perform second addition of a third device by second scale-out processing with regard to the first device in accordance with a total load of a group including the first device and the second device after the first scale-out processing.

### CROSS-REFERENCE TO RELATED APPLICATION

This application is based upon and claims the benefit of priority of the prior Japanese Patent Application No. 2017-252623, filed on Dec. 27, 2017, the entire contents of which are incorporated herein by reference.

### FIELD

The embodiments discussed herein are related to a scale-in and scale-out technology.

### BACKGROUND

Some cloud systems providing service in response to a request from a terminal of a user have an auto-scaling function that increases or decreases the number of servers to be used, according to a change in server load due to an increase or decrease in the number of accesses from terminals of users or the like. In auto-scaling, the processing of decreasing the number of servers is referred to as a scale-in, and the processing of increasing the number of servers is referred to as a scale-out. The servers in the auto-scaling are often virtual machines.

When too large an amount of accesses to be processed by existing virtual machines are received, for example, the number of servers is increased by executing a scale-out. Thus, processing power is enhanced, so that the accesses may be processed with a delay suppressed. When the accesses are thereafter decreased, the servers are reduced by executing a scale-in. It is thereby possible to optimize resources and reduce unnecessary cost.

When a scale-out is executed, execution determination is made according to a direct load on each individual server such as a central processing unit (CPU) utilization rate or the like. Further, in the scale-out, processing is performed which includes generation of a virtual machine and addition of various settings to the generated virtual machine. It thus takes a certain time to add a server. Therefore, starting a scale-out does not mean a sudden decrease in the direct load on each individual server. For such reasons, when the direct load is monitored as in a manner thus far and the scale-out execution determination is continued after the scale-out is started, an excessive scale-out may be executed.

Accordingly, in order to avoid the excessive scale-out, a cooldown is performed in which further auto-scaling during the scale-out is not accepted for a certain period. A sufficient time to complete auto-scaling is set as the certain period during which this cooldown is performed.

As a technology of such auto-scaling, there is a technology that calculates the number of servers to be used from relation between server load information, the number of processing requests from a client, and a maximum number of processing requests in the past, and performs auto-scaling. In addition, there is a technology that determines the number of computers for which auto-scaling is performed from a load amount of all of load distribution target computers. Further, there is a technology that determines a minimum number of servers to be used from the number of transactions and the CPU utilization rate of each server.

Related technologies are disclosed in Japanese Laid-open Patent Publication No. 2011-13870, Japanese Laid-open Patent Publication No. 2005-11331, and Japanese Laid-open Patent Publication No. 2016-6638, for example.

### SUMMARY

According to an aspect of the embodiments, a management device includes one or more memories, and one or more processors configured to perform first addition of a second device by first scale-out processing with regard to a first device in accordance with a load of the first device, and perform second addition of a third device by second scale-out processing with regard to the first device in accordance with a total load of a group including the first device and the second device after the first scale-out processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing system according to a first embodiment;

FIG. 2 is a block diagram of a monitoring server;

FIG. 3 is a diagram of assistance in explaining an outline of a scale-out;

FIG. 4 is a flowchart of monitoring information obtainment processing;

FIG. 5 is a flowchart of scale-out processing; and

FIG. 6 is a diagram of a hardware configuration of a monitoring server.

### DESCRIPTION OF EMBODIMENTS

However, when a load has a tendency to increase during the scale-out, it may be desirable to add an additional server. For example, there may be a case where the CPU utilization rate exceeds a threshold value and scaling out by one server is performed, but the number of requests has a tendency to increase during the scaling out, and thus the addition of one server is not sufficient. In such a case, the existing technology does not make scale-out execution determination and thus does not receive additional requests during the cooldown period. It is therefore difficult to deal immediately with the load that continues to increase. Consequently, it is difficult to secure an appropriate number for stabilizing the load after completion of the scaling out.

In addition, even with the use of the technology which performs auto-scaling based on relation between server load information, the number of processing requests from a client, and a maximum number of processing requests in the past, it is difficult to deal immediately with the load that continues to increase while suppressing an excessive scale-out, and operate the system stably. In addition, even with the use of the technology which performs auto-scaling based on the load amount of all of load distribution target computers or the technology which performs auto-scaling based on the number of transactions and the CPU utilization rate of each server, it is difficult to secure an appropriate number for stabilizing the load after completion of the scaling out.

Embodiments of an information processing device, an information processing system, and an information processing method disclosed in the present application will hereinafter be described in detail with reference to the drawings. It is to be noted that the following embodiments do not limit the information processing device, the information processing system, and the information processing method disclosed in the present application.

### First Embodiment

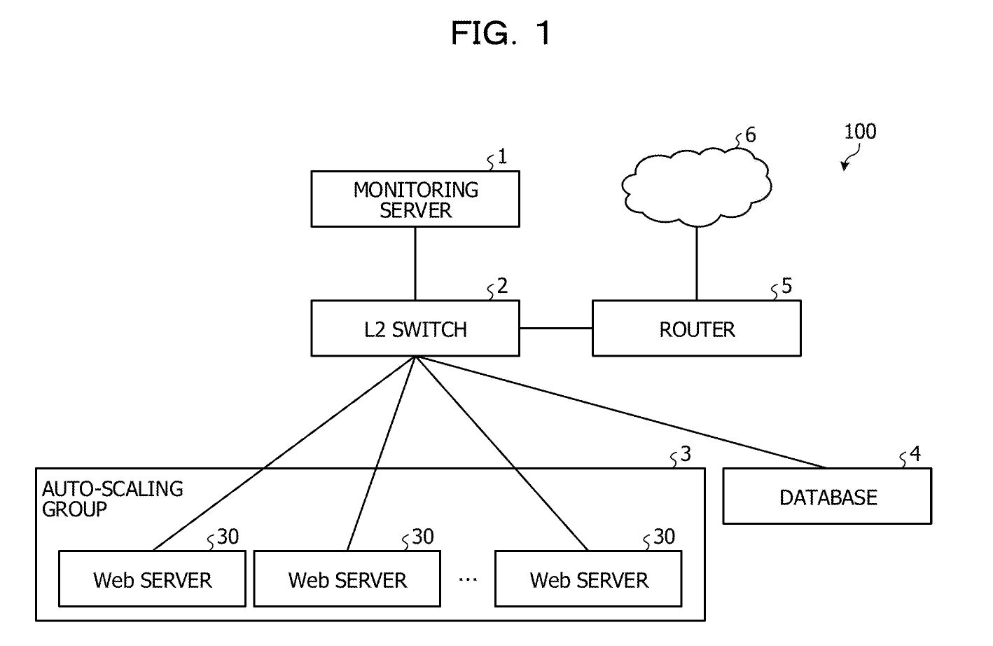

FIG. 1 is a block diagram of an information processing system according to a first embodiment. An information processing system 100 according to the present embodiment includes a monitoring server 1, an L (Layer) 2 switch 2, an auto-scaling group 3, a database 4, and a router 5.

The monitoring server 1, the router 5, and the database 4 are coupled to the L2 switch 2. In addition, the auto-scaling group 3 is physically included in one or a plurality of physical servers (not illustrated). The auto-scaling group 3 includes a plurality of Web servers 30, which are virtual machines generated on the physical servers. In actuality, the physical servers belonging to the auto-scaling group 3 are coupled to the L2 switch 2. For the convenience of description, however, FIG. 1 describes each of the Web servers 30 as being coupled to the L2 switch 2. Further, the router 5 is coupled to an external network 6 such as the Internet or the like.

The Web servers 30 are coupled to the external network 6 via the L2 switch 2 and the router 5. Then, in response to a request from an external client, the request being received via the external network 6, the Web servers 30 provide specified information to the client as a request source. The L2 switch 2 performs load balancing for each of the Web servers 30 belonging to the auto-scaling group 3.

The L2 switch 2 has a function of a load balancing server that performs load balancing for the Web servers 30 belonging to the auto-scaling group 3. For example, the L2 switch 2 receives a request from a client via the external network 6, and transmits the request to a Web server 30 selected so as to make loads uniform. For example, the L2 switch 2 selects the Web server 30 in a round robin manner or the like. Thereafter, the L2 switch 2 receives a response to the request from the Web server 30, and transmits the received response to the client as a transmission source of the request via the external network 6.

In addition, the L2 switch 2 obtains the number of requests per unit time to the auto-scaling group 3. The L2 switch 2 then stores the obtained number of requests per unit time to the auto-scaling group 3 in the database 4. The number of requests per unit time to the auto-scaling group 3 corresponds to an example of “load information of a group.”

In addition, the L2 switch 2 obtains the CPU utilization rates of the respective Web servers 30 belonging to the auto-scaling group 3 from the respective Web servers 30. The L2 switch 2 then stores, in the database 4, the obtained CPU utilization rates of the respective Web servers 30 belonging to the auto-scaling group 3. The CPU utilization rates correspond to an example of “load information of a first information processing device.”

The monitoring server 1 communicates with each of the Web servers 30 and the database 4 via the L2 switch 2. The monitoring server 1 performs construction of the Web servers 30 as virtual machines for the auto-scaling group 3 and auto-scaling.

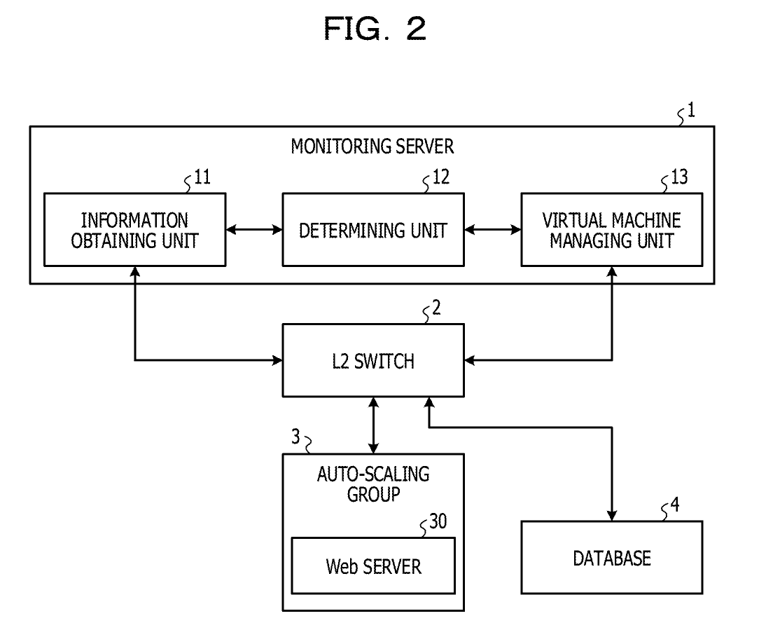

FIG. 2 is a block diagram of a monitoring server. The monitoring server 1 includes an information obtaining unit 11, a determining unit 12, and a virtual machine managing unit 13. The monitoring server 1 corresponds to an example of a “management device.”

The information obtaining unit 11 sets, as monitoring information, the CPU utilization rates of the respective Web servers 30 belonging to the auto-scaling group 3 and the number of requests of the Web servers 30 per unit time in the auto-scaling group 3. The information obtaining unit 11 obtains the CPU utilization rates by polling each of the Web servers 30 belonging to the auto-scaling group 3. The information obtaining unit 11 then stores the obtained CPU utilization rates of the respective Web servers 30 in the database 4. In addition, the information obtaining unit 11 polls the L2 switch 2, and obtains the number of requests of the Web servers 30 per unit time in the auto-scaling group 3. The information obtaining unit 11 then stores the obtained number of requests of the Web servers 30 per unit time in the auto-scaling group 3 in the database 4.

In addition, the information obtaining unit 11 receives, from the determining unit 12, an input of a kind of determination information to be collected. Kinds of determination information include the CPU utilization rates of the respective Web servers 30 and the number of requests per unit time in the auto-scaling group 3. The information obtaining unit 11 periodically obtains the specified kind of determination information from the database 4 via the L2 switch 2. For example, the information obtaining unit 11 collects the determination information at intervals of one minute.

For example, when the information obtaining unit 11 collects the CPU utilization rates of the Web servers 30, the information obtaining unit 11 sequentially polls the database 4 with regard to each of the Web servers 30, and thereby obtains information regarding the CPU utilization rates of the respective Web servers 30. This corresponds to one time of collection of determination information, the collection being performed periodically. In addition, when the information obtaining unit 11 collects the number of requests per unit time in the auto-scaling group 3, the information obtaining unit 11 polls the database 4 with regard to the auto-scaling group 3, and thereby collects the number of requests per unit time in the auto-scaling group 3.

Here, in the present embodiment, the information obtaining unit 11 obtains monitoring information that may be determination information for scale-out execution determination in advance, stores the monitoring information in the database 4 in advance, and obtains the determination information to be actually used from the database at timing of collection of the determination information. However, the information obtaining unit 11 may obtain the determination information by a procedure other than this procedure. For example, at timing of collection of the determination information, the information obtaining unit 11 may obtain the CPU utilization rates or the number of requests per unit time in the auto-scaling group 3 directly from the Web servers 30 or the L2 switch 2.

In addition, while the above description is made of a case where there is one auto-scaling group 3, there may be a plurality of auto-scaling groups 3. In that case, the information obtaining unit 11 receives an input of a kind of determination information for each of the auto-scaling groups 3 from the determining unit 12, and collects the determination information specified for each of the auto-scaling groups 3.

Then, after completing the collection of the determination information specified from the determining unit 12, the information obtaining unit 11 outputs the collected determination information to the determining unit 12.

When the determining unit 12 has not given an instruction for a scale-out to the virtual machine managing unit 13, the determining unit 12 uses the CPU utilization rates of the Web servers 30 as a metric to be used for scale-out determination. The determining unit 12 then notifies the information obtaining unit 11 of the CPU utilization rates of the Web servers 30 as a kind of determination information.

The determining unit 12 thereafter receives an input of the CPU utilization rates of the Web servers 30 belonging to the auto-scaling group 3 from the information obtaining unit 11. The determining unit 12 has, in advance, a CPU utilization rate threshold value for determining whether or not to execute a scale-out. For example, the determining unit 12 stores a CPU utilization rate of 80% as the CPU utilization rate threshold value. Further, the determining unit 12 has, as a condition for scale-out execution determination, contents indicating that a scale-out is to be performed when the CPU utilization rate of one of the Web servers 30 is equal to or higher than the CPU utilization rate threshold value. The Web servers 30 belonging to the auto-scaling group 3 in a state in which scale-out is not being executed correspond to an example of a “first information processing device.”

The determining unit 12 determines whether or not there is a Web server 30 whose CPU utilization rate is equal to or higher than the CPU utilization rate threshold value among the Web servers 30 belonging to the auto-scaling group 3. When there is no Web server 30 whose CPU utilization rate is equal to or higher than the CPU utilization rate threshold value, the determining unit 12 waits to make auto-scaling execution determination until next timing of information collection by the information obtaining unit 11 without scaling out the auto-scaling group 3.

When there is a Web server 30 whose CPU utilization rate is equal to or higher than the CPU utilization rate threshold value, on the other hand, the determining unit 12 decides to add a Web server 30. Here, the determining unit 12 changes the condition for scale-out execution determination at next timing. For example, the determining unit 12 changes the metric used for scale-out execution determination to the number of requests per unit time in the auto-scaling group 3. Here, when the determining unit 12 changes the metric used for scale-out determination, the determining unit 12 changes the metric before next timing of collection of determination information by the information obtaining unit 11. Then, the determining unit 12 notifies the information obtaining unit 11 of the number of requests per unit time in the auto-scaling group 3 as a kind of determination information.

Here, in the present embodiment, the CPU utilization rates of the Web servers 30 are used as information used for auto-scaling execution determination when auto-scaling is not performed. However, other information may be used as long as the information indicates a direct load on each of the Web servers 30. For example, memory utilization rates may also be used as information used for auto-scaling execution determination when auto-scaling is not performed.

Further, by using the following Equations (1) and (2), the determining unit 12 obtains a request number threshold value as a threshold value used for scale-out execution determination when the number of requests per unit time in the auto-scaling group 3 is used. Here, N is the number of Web servers 30 belonging to the auto-scaling group 3.

[Expression 1]

(Number of Requests per Unit Time in Auto-Scaling Group 3)/N=Number of Requests per Unit Time per Web Server 30 (1)

[Expression 2]

(Number of Requests per Unit Time per Web Server 30)×(N+1)=Request Threshold Value (2)

For example, the determining unit 12 calculates the present number of requests per Web server 30 by dividing the present number of requests per unit time by the present number of Web servers 30. Then, the determining unit 12 calculates the request number threshold value by multiplying a value obtained by adding one to the present number of Web servers 30 by the number of requests per Web server 30.

The determining unit 12 then changes the condition for scale-out execution determination to contents indicating that a scale-out is to be performed when the number of requests per unit time in the auto-scaling group 3 exceeds the request number threshold value. For example, the determining unit 12 performs a scale-out when “Present Number of Requests per Unit Time in Auto-Scaling Group 3>Request Threshold Value.”

The determining unit 12 thereafter instructs the virtual machine managing unit 13 to add a Web server 30. The determining unit 12 then waits to make auto-scaling execution determination until next timing of information collection by the information obtaining unit 11.

When the determining unit 12 instructs the virtual machine managing unit 13 to add a Web server 30, the determining unit 12 performs the following processing. When timing of information collection by the information obtaining unit 11 arrives in a state in which a notification of completion of the addition of a Web server 30 is not yet received from the virtual machine managing unit 13, the determining unit 12 receives an input of the number of requests per unit time in the auto-scaling group 3 from the information obtaining unit 11. The determining unit 12 then compares the number of requests per unit time and the request number threshold value with each other. When the number of requests per unit time is less than the request number threshold value, the determining unit 12 waits to make auto-scaling execution determination until next timing of information collection by the information obtaining unit 11 without further adding a Web server 30 to the auto-scaling group 3.

When the number of requests per unit time is equal to or more than the request number threshold value, the determining unit 12 decides to further add a Web server 30, for example, further perform auto-scaling. Here, the determining unit 12 changes the condition for scale-out execution determination at next timing. For example, the determining unit 12 maintains the number of requests per unit time in the auto-scaling group 3 as it is as the metric used for scale-out execution determination.

Further, the determining unit 12 calculates a new request number threshold value by using Equations (1) and (2). For example, the determining unit 12 calculates the present number of requests per Web servers 30 by dividing the present number of requests per unit time by the present number of Web servers 30. The determining unit 12 then calculates a next request number threshold value by multiplying a value obtained by adding one to the present number of Web servers 30 by the number of requests per Web server 30. The determining unit 12 thereafter changes the condition for scale-out execution determination to contents indicating that a scale-out is to be performed when the number of requests per unit time in the auto-scaling group 3 exceeds the next request number threshold value.

The determining unit 12 thereafter instructs the virtual machine managing unit 13 to add a Web server 30. The determining unit 12 then waits to make auto-scaling execution determination until next timing of information collection by the information obtaining unit 11.

When next timing of information collection by the information obtaining unit 11 thereafter arrives in a state in which a notification of completion of the addition of a Web server 30 is not yet received from the virtual machine managing unit 13, the determining unit 12 repeats scale-out execution determination using the number of requests per unit time in the auto-scaling group 3. Then, each time the determining unit 12 decides to add a Web server 30, the determining unit 12 changes the condition for scale-out execution determination.

Here, in the present embodiment, the number of requests per unit time in the auto-scaling group 3 is used as information used to determine whether or not to further add a Web server 30 during the addition of a Web server 30 by a scale-out. However, as this information, other information may be used as long as the information does not depend on resources in each Web server 30 such as a CPU, a memory, or the like, and indicates a load on the auto-scaling group 3. This information is particularly preferably information related to a part as a bottleneck in the auto-scaling group. This information may, for example, be the number of network packets, disk input output (TO), the number of connections of the Web servers, or the like. In addition, consideration may be given to the state of a server performing other processing, such as an application server, a database server, or the like coupled to the Web servers. For example, a method may be adopted which determines that a server is to be added when the server performing the other processing has a low load rate.

When the determining unit 12 receives a notification of completion of the addition of a Web server 30 from the virtual machine managing unit 13 after instructing the virtual machine managing unit 13 to execute a scale-out, on the other hand, the determining unit 12 changes the condition for scale-out execution determination by initializing the metric used for scale-out determination. For example, the determining unit 12 changes the metric used for scale-out determination to the CPU utilization rates of the Web servers 30. Also in this case, the determining unit 12 changes the metric before next timing of collection of determination information by the information obtaining unit 11. The determining unit 12 then notifies the information obtaining unit 11 of the CPU utilization rates of the Web servers 30 as a kind of determination information. The determining unit 12 further changes the condition for scale-out execution determination to contents indicating that a scale-out is to be performed when the CPU utilization rate of one of the Web servers 30 is equal to or higher than the CPU utilization rate threshold value.

The determining unit 12 makes the scale-out execution determination described above at each timing of information collection by the information obtaining unit 11. A Web server 30 newly added to the auto-scaling group 3 by a scale-out corresponds to an example of a “second information processing device.”

The determining unit 12 also makes a determination for a scale-in at timing of information collection by the information obtaining unit 11. The determining unit 12 has, in advance, a scale-in threshold value for determining whether or not to execute a scale-in. The scale-in threshold value is, for example, the CPU utilization rate of a Web server 30. The determining unit 12 determines whether or not the CPU utilization rate of one of the Web servers 30 is equal to or less than the scale-in threshold value. When there is no Web server 30 whose CPU utilization rate is equal to or lower than the scale-in threshold value, the determining unit 12 does not execute a scale-in, and waits until next timing of information collection by the information obtaining unit 11.

When there is a Web server 30 whose CPU utilization rate is equal to or lower than the scale-in threshold value, on the other hand, the determining unit 12 instructs the virtual machine managing unit 13 to reduce the Web servers 30. The determining unit 12 thereafter waits until next timing of information collection by the information obtaining unit 11. In the case of a scale-in, the simple removal of the target Web server 30 from the load balancing group is performed instantly. There is thus a small possibility that the state of the auto-scaling group 3 may change in the meantime and a further reduction of the Web servers 30 may be requested. Therefore, in the case of a scale-in, unlike a scale-out, the determining unit 12 does not further delete a Web server 30 during the execution of the scale-in, but waits for next timing of information collection by the information obtaining unit 11.

The virtual machine managing unit 13 generates the number of Web servers 30, the number being specified from an administrator, and sets the Web servers 30 as the auto-scaling group 3. The virtual machine managing unit 13 then instructs the L2 switch 2 to perform load balancing for the auto-scaling group 3. The virtual machine managing unit 13 thereby generates the group of the Web servers 30 for which load balancing is performed.

When it is thereafter determined that a scale-out is to be executed, the virtual machine managing unit 13 receives an instruction to add a Web server 30 from the determining unit 12. The virtual machine managing unit 13 then generates a new Web server 30 in the auto-scaling group 3. The virtual machine managing unit 13 thereafter makes settings on the newly generated Web server 30 so that load balancing may be performed with Web servers 30 belonging to another auto-scaling group 3. When the generation and setting of the Web server 30 by the virtual machine managing unit 13 are completed, the addition of the Web server 30 is completed. When the Web server 30 is added to the auto-scaling group 3, the Web server 30 is automatically incorporated into the group for load balancing by the L2 switch 2.

When the virtual machine managing unit 13 receives an instruction to add a Web server 30 from the determining unit 12 before completing the addition of the Web server 30 during the execution, the virtual machine managing unit 13 generates another new Web server 30 in the auto-scaling group 3. When completing the addition of all of the Web servers 30 during the execution, on the other hand, the virtual machine managing unit 13 notifies the determining unit 12 of completion of the addition of the Web servers 30.

In addition, when it is determined that a scale-in is to be executed, the virtual machine managing unit 13 receives an instruction to reduce the Web servers 30 from the determining unit 12. The virtual machine managing unit 13 then deletes a Web server 30 from the auto-scaling group 3. When the Web server 30 is deleted from the auto-scaling group 3, the Web server 30 is automatically excluded from the group for load balancing by the L2 switch 2. The virtual machine managing unit 13 corresponds to an example of a “managing unit.”

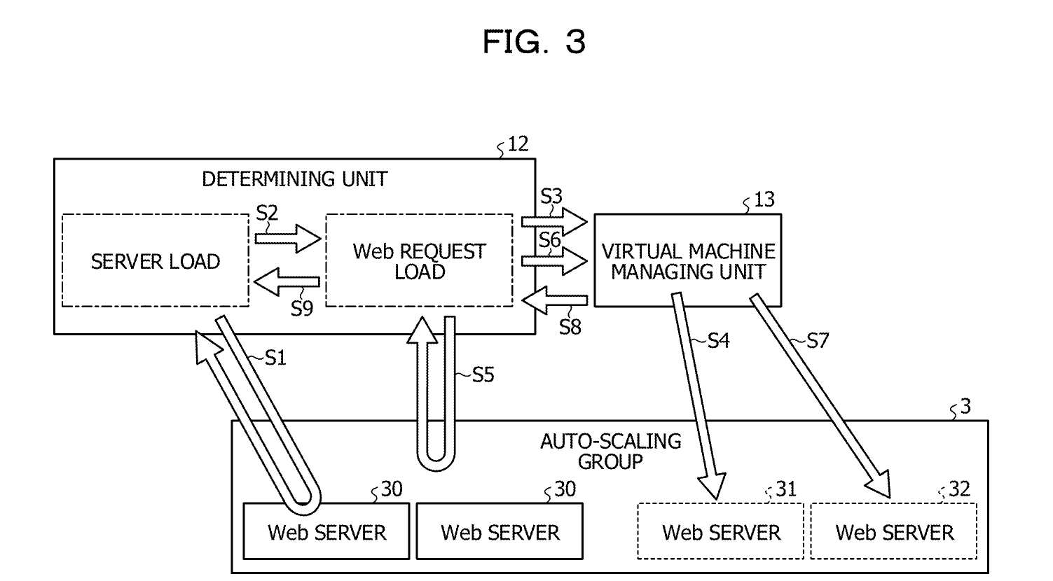

An entire outline of a scale-out by the monitoring server 1 will next be further described with reference to FIG. 3. FIG. 3 is a diagram of assistance in explaining an outline of a scale-out. Information enclosed by alternate long and short dashed lines in FIG. 3 is metrics used for scale-out execution determination. In addition, Web servers 31 and 32 represented by broken lines illustrate Web servers 30 to be added.

When the determining unit 12 has not given an instruction to add a Web server 30, the determining unit 12 uses the CPU utilization rate of a Web server 30, the CPU utilization rate being a server load, as the metric used for scale-out execution determination. The determining unit 12 obtains the CPU utilization rate of a Web server 30 as a server load (step S1). Here, to facilitate understanding, FIG. 3 indicates that the CPU utilization rate is obtained directly from the Web server 30. In actuality, however, the determining unit 12 obtains the CPU utilization rate of the Web server 30 from the database 4.

The determining unit 12 then determines whether or not the CPU utilization rate is equal to or higher than the CPU utilization rate threshold value. The following description will be made of a case where the CPU utilization rate is equal to or higher than the CPU utilization rate threshold value. The determining unit 12 decides to execute a scale-out. The determining unit 12 then changes the metric used for scale-out execution determination from the server load to the number of Web requests per unit time as a Web request load (step S2). The determining unit 12 further calculates a request threshold value.

Next, the determining unit 12 instructs the virtual machine managing unit 13 to add a Web server 30 (step S3). Receiving the instruction to add a Web server 30 from the determining unit 12, the virtual machine managing unit 13 adds a new Web server 31 to the auto-scaling group 3 (step S4).

Thereafter, at next timing of information collection by the information obtaining unit 11, the determining unit 12 obtains the number of Web requests per unit time in the auto-scaling group 3 as the Web request load (step S5). Also in this case, to facilitate understanding, FIG. 3 indicates that the number of Web requests is obtained directly from the auto-scaling group 3. In actuality, however, the determining unit 12 obtains the number of Web requests per unit time in the auto-scaling group 3 from the database 4.

The determining unit 12 then determines whether or not the number of Web requests per unit time in the auto-scaling group 3 is equal to or more than the request number threshold value. The following description will be made of a case where the number of Web requests per unit time in the auto-scaling group 3 is equal to or more than the request number threshold value. The determining unit 12 decides to add a Web server 30. The determining unit 12 then instructs the virtual machine managing unit 13 to add a Web server 30 (step S6).

Receiving the instruction to add a Web server 30 from the determining unit 12, the virtual machine managing unit 13 adds another new Web server 32 to the auto-scaling group 3 (step S7). The virtual machine managing unit 13 thereafter notifies the determining unit 12 of completion of the addition of the Web servers 30 (step S8).

Receiving the notification of the completion of the addition of the Web servers 30 from the virtual machine managing unit 13, the determining unit 12 changes the metric used for scale-out execution determination from the Web request load to the CPU utilization rate of a Web server 30 as the server load (step S9).

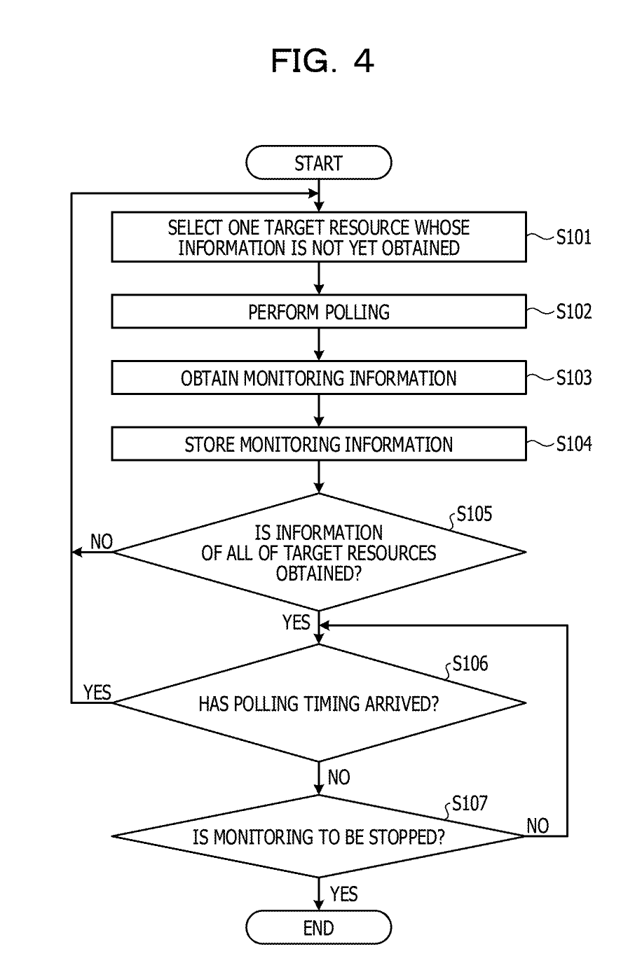

A flow of monitoring information obtainment processing will next be described with reference to FIG. 4. FIG. 4 is a flowchart of monitoring information obtainment processing.

The information obtaining unit 11 sets the auto-scaling group 3 and the Web servers 30 as monitoring target resources, and selects one target resource whose information is not yet obtained from among the target resources (step S101).

Next, the information obtaining unit 11 performs polling that inquires of the selected target resource about monitoring information (step S102). Here, when the selected target resource is the auto-scaling group 3, the information obtaining unit 11 polls the L2 switch 2.

Then, the information obtaining unit 11 obtains the monitoring information from the selected target resource (step S103). For example, when the selected target resource is a Web server 30, the information obtaining unit 11 obtains the CPU utilization rate of the selected Web server 30. In addition, when the selected target resource is the auto-scaling group 3, the information obtaining unit 11 obtains the number of requests per unit time in the selected auto-scaling group 3 from the L2 switch 2.

Next, the information obtaining unit 11 stores the obtained monitoring information in the database 4 (step S104).

The information obtaining unit 11 determines whether or not the information of all of the target resources is obtained (step S105). When there is a target resource whose information is not obtained (step S105: negative), the information obtaining unit 11 returns to step S101.

When the information of all of the target resources is obtained (step S105: affirmative), on the other hand, the information obtaining unit 11 determines whether or not next polling timing has arrived (step S106). When next polling timing has arrived (step S106: affirmative), the information obtaining unit 11 returns to step S101.

When next polling timing has not arrived (step S106: negative), on the other hand, the information obtaining unit 11 determines whether or not to stop monitoring (step S107). The information obtaining unit 11 stops monitoring when the monitoring server 1 is shut down, for example.

When monitoring is not to be stopped (step S107: negative), the information obtaining unit 11 returns to step S106, and waits until polling timing arrives. When monitoring is to be stopped (step S107: affirmative), on the other hand, the information obtaining unit 11 ends the monitoring information obtainment processing.

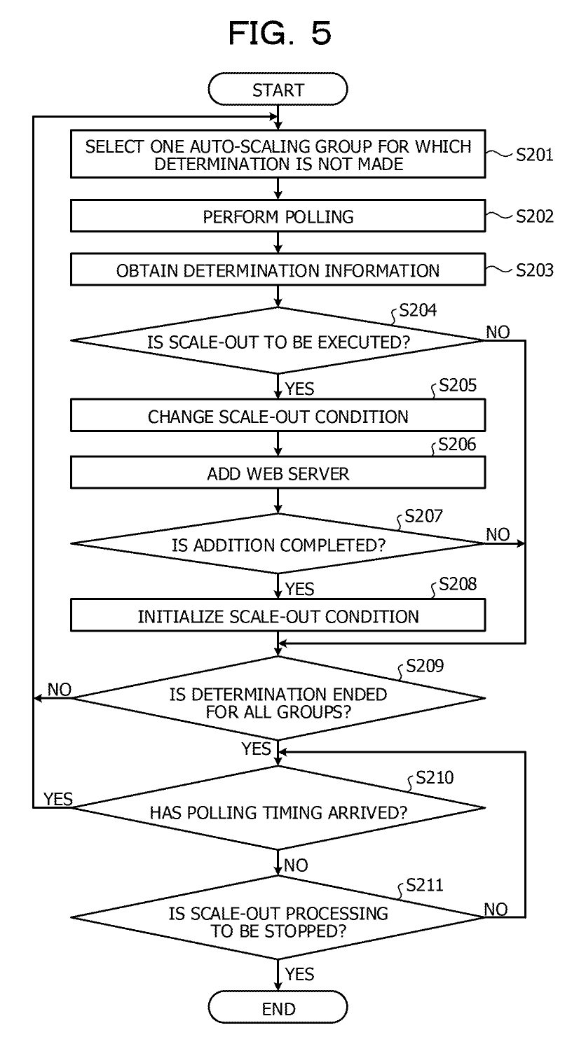

A flow of scale-out processing will next be described with reference to FIG. 5. FIG. 5 is a flowchart of scale-out processing. The following description will be made of a case where there is a plurality of auto-scaling groups 3.

The information obtaining unit 11 selects one auto-scaling group 3 for which determination is not made (step S201).

The information obtaining unit 11 performs polling of the database 4, the polling inquiring about determination information of the selected auto-scaling group 3 (step S202). Here, when the addition of a Web server 30 is not being performed in the selected auto-scaling group 3, the information obtaining unit 11 inquires about the CPU utilization rate of each Web server 30 belonging to the selected auto-scaling group 3. When the addition of a Web server 30 in the selected auto-scaling group 3 is being performed, on the other hand, the information obtaining unit 11 inquires about the number of requests per unit time in the selected auto-scaling group 3.

The information obtaining unit 11 obtains the determination information of the selected auto-scaling group 3 (step S203). The information obtaining unit 11 thereafter outputs the obtained determination information to the determining unit 12.

The determining unit 12 receives the input of the determination information from the information obtaining unit 11. Then, using the obtained determination information, the determining unit 12 determines whether or not to execute a scale-out (step S204). When a scale-out is not to be executed (step S204: negative), the scale-out processing proceeds to step S209.

When a scale-out is to be executed (step S204: affirmative), the determining unit 12 changes a scale-out condition as the condition for scale-out execution determination (step S205). For example, when the CPU utilization rate is set as the metric for scale-out execution determination, the determining unit 12 changes the metric for scale-out execution determination to the number of requests per unit time in the auto-scaling group 3. The determining unit 12 further obtains a request number threshold value. The determining unit 12 then sets, as the scale-out condition, a condition that the number of requests per unit time in the auto-scaling group 3 is equal to or more than the request number threshold value. In addition, when the number of requests per unit time in the auto-scaling group 3 is set as the metric for scale-out execution determination, the determining unit 12 calculates and changes the request number threshold value.

Thereafter, the determining unit 12 instructs the virtual machine managing unit 13 to add a Web server 30. Receiving the instruction from the determining unit 12, the virtual machine managing unit 13 adds a Web server 30 to the selected auto-scaling group 3 (step S206).

Thereafter, the determining unit 12 determines whether or not the addition of the Web server 30 is completed based on the presence or absence of a notification of completion of the addition of a Web server 30 from the virtual machine managing unit 13 (step S207). When the addition of the Web server 30 is not completed (step S207: negative), the determining unit 12 proceeds to step S209.

When the addition of a Web server 30 is completed (step S207: affirmative), on the other hand, the determining unit 12 initializes the scale-out condition by returning the metric for scale-out execution determination to the CPU utilization rate of a Web server 30 (step S208).

Thereafter, the determining unit 12 determines whether or not the scale-out execution determination is ended for all of the auto-scaling groups 3 (step S209). When there is an auto-scaling group 3 for which the scale-out execution determination is not made (step S209: negative), the determining unit 12 returns to step S201.

When the scale-out execution determination is ended for all of the auto-scaling groups 3 (step S209: affirmative), on the other hand, the determining unit 12 determines whether or not next polling timing has arrived (step S210). When next polling timing has arrived (step S210: affirmative), the determining unit 12 returns to step S201.

When next polling timing has not arrived (step S210: negative), on the other hand, the determining unit 12 determines whether or not to stop the scale-out processing (step S211). The determining unit 12 stops the scale-out processing when the monitoring server 1 is shut down, for example.

When the scale-out processing is not to be stopped (step S211: negative), the determining unit 12 returns to step S210, and waits until polling timing arrives. When the scale-out processing is to be stopped (step S211: affirmative), on the other hand, the determining unit 12 ends the scale-out processing.

Here, in the present embodiment, description has been made of a scale-out by taking the load-balanced Web servers 30 as an example. However, the processing performed by the information processing devices as targets of the scale-out is not limited to this. It suffices for each of the information processing devices as targets of the scale-out to perform processing in parallel based on load balancing. Each of the information processing devices as targets of the scale-out may be a database server or an application server.

In addition, in the present embodiment, the monitoring server 1 obtains the monitoring information and the determination information by performing polling. However, a method of obtaining these pieces of information is not limited to this. For example, the Web servers 30 and the L2 switch 2 as monitoring target resources may actively transmit the information to the monitoring server 1.

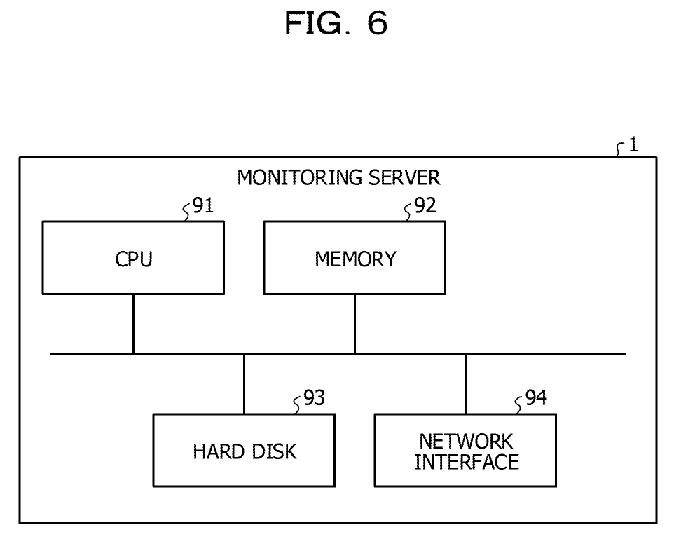

A hardware configuration of the monitoring server 1 will next be described with reference to FIG. 6. FIG. 6 is a diagram of a hardware configuration of a monitoring server. As illustrated in FIG. 6, the monitoring server 1 includes a CPU 91, a memory 92, a hard disk 93, and a network interface 94.

The CPU 91 is coupled to the memory 92, the hard disk 93, and the network interface 94 via a bus.

The network interface 94 is a communication interface for the CPU 91 to transmit and receive data to and from the L2 switch 2.

The hard disk 93 stores various programs including a program that includes a plurality of instructions is executed by the CPU 91 to implement the functions of the information obtaining unit 11, the determining unit 12, and the virtual machine managing unit 13 illustrated in FIG. 2. In addition, the hard disk 93 stores various kinds of information when the functions of the information obtaining unit 11, the determining unit 12, and the virtual machine managing unit 13 are implemented.

The CPU 91 implements the functions of the information obtaining unit 11, the determining unit 12, and the virtual machine managing unit 13 illustrated in FIG. 2 by reading the various programs from the hard disk 93, expanding the programs in the memory 92, and executing the programs.

As described above, when the addition of a server by a scale-out is not performed, the monitoring server according to the present embodiment determines whether or not to add another server by using a CPU utilization rate as a server load. In addition, when the addition of a server by a scale-out is being performed, the monitoring server according to the present embodiment determines whether or not to add another server by using the number of requests per unit time in the auto-scaling group as a load on the whole of the group as a target of scale-out determination. It is thereby possible to suppress an excessive server addition due to a scale-out by the cooldown function, and add a server when the load increases during the addition of a server by the scale-out. For example, even when the load increases during the addition of a server by the scale-out, an appropriate number of servers may be secured, and the system may be operated stably.

In addition, even when a human does not check whether or not the load is increasing during a scale-out, a server may be added automatically. Manual monitoring work may therefore be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management device comprising:
one or more memories; and
one or more processors coupled to the one or more processors configured to
perform first addition of a second device by first scale-out processing with regard to a first device in accordance with a load of the first device, and
perform second addition of a third device by second scale-out processing with regard to the first device in accordance with a total load of a group including the first device and the second device after the first scale-out processing.

2. The management device according to claim 1, wherein
the load is a load based on a central processing unit utilization rate of the first device, and
the total load is a load based on a sum of a first communication amount of the first device and a second communication amount of the second device.

3. The management device according to claim 2, wherein
the first addition includes determining whether the central processing unit utilization rate of the first device is no less than a first threshold value, and
the second addition includes determining whether the sum is no less a second threshold value.

4. The management device according to claim 1, wherein
the one or more processors are configured to, when a decision to perform the second scale-out processing is made, change a threshold for determining whether the one or more processors execute a third scale-out processing with regard to the first device in accordance with the total load of the group.

5. The management device according to claim 1, wherein
the one or more processors are configured to
periodically perform determination of whether the one or more processors execute a third scale-out processing with regard to the first device.

6. The management device according to claim 1, wherein
the first device and the second device are virtual machines.

7. A computer-implemented management method comprising:
first adding a second device by first scale-out processing with regard to a first device in accordance with a load of the first device; and
second adding a third device by second scale-out processing with regard to the first device in accordance with a total load of a group including the first device and the second device after the first scale-out processing.

8. The management method according to claim 7, wherein
the load is a load based on a central processing unit utilization rate of the first device, and
the total load is a load based on a sum of a first communication amount of the first device and a second communication amount of the second device.

9. The management method according to claim 8, wherein
the first adding includes determining whether the central processing unit utilization rate of the first device is no less than a first threshold value, and
the second adding includes determining whether the sum is no less a second threshold value.

10. The management method according to claim 7, further comprising:
when a decision to perform the second scale-out processing is made, changing a threshold for determining whether a third scale-out processing with regard to the first device is executed in accordance with the total load of the group.

11. The management method according to claim 7, further comprising:
periodically determining whether a third scale-out processing with regard to the first device is executed.

12. The management device according to claim 7, wherein
the first device and the second device are virtual machines.

13. A non-transitory computer-readable medium storing instructions executable by one or more computer, the instructions comprising:
one or more instructions for first adding a second device by first scale-out processing with regard to a first device in accordance with a load of the first device; and
one or more instructions for second adding a third device by second scale-out processing with regard to the first device in accordance with a total load of a group including the first device and the second device after the first scale-out processing.
